(19) United States
(12) Patent Application Publication
(10) Pub. No.: US 2011/0288766 A1
(43) Pub. Date: Nov. 24, 2011

(54) NAVIGATION DEVICE, NAVIGATION METHOD, NAVIGATION PROGRAM, AND RECORDING MEDIUM

(75) Inventors: Makoto Nagasawa, Setagaya (JP); Kenji Kikui, Tokyo (JP); Kumiko Shudo, Minato (JP); Satoshi Sasaki, Saitama (JP); Kazuo Ikeda, Yokohama (JP)

(73) Assignees: INCREMENT P CORPORATION, Tokyo (JP); PIONEER CORPORATION, Tokyo (JP)

(21) Appl. No.: 12/865,026

(22) PCT Filed: Jan. 29, 2008
(86) PCT No.: PCT/JP2008/051291

§ 371 Date: Sep. 29, 2010

(51) Int. Cl. G01C 21/36

(52) U.S. Cl. 701/201

(57) ABSTRACT

A navigation apparatus that provides guidance along a route to a destination using a guidance image on which a plurality of guidance signs, respectively indicative of a guidance direction at a guidance point, are arranged in order of proximity to a current point, includes a setting unit that preliminarily sets a first given distance from the current point; an extracting unit that extracts a given guidance point on the route; a calculating unit that calculates a distance from the current point to the given guidance point extracted by the extracting unit; and a display control unit that when the distance to the given guidance point calculated by the calculating unit becomes equal to or less than the first given distance, changes a color of a guidance sign at the guidance point to a color different from an current display color.

### TECHNICAL FIELD

The present invention relates to a navigation apparatus, a navigation method, a navigation program, and a recording medium.

### BACKGROUND ART

In recent years, a mobile object is equipped with a navigation apparatus that searches for a route to a destination to provide guidance. Among such navigation apparatuses, a navigation apparatus is known that upon traveling on an express way, displays not only an ordinary map but also a distance and time between guidance points as well as the distance and the time to reach a guidance point such as a junction, service area, and interchange.

To achieve such an apparatus, a technique has been proposed, according to which, specifically, for example, plural windows each indicating a guidance direction at each guidance point are arranged from the lower side toward the upper side in the order of proximity to the position of the user's vehicle to display the windows in such a manner that the sizes of the windows are increased according to the proximity of the driver's vehicle to the displayed position (see, e.g., Patent Document 1).
Patent Document 1: Japanese Patent No. 3948299

### DISCLOSURE OF INVENTION

### Problem to be Solved by the Invention

According to the technique described in the Patent Document 1, guidance is provided by merely displaying in the order of passage through guidance points. This poses a problem in that a sense of the distance is not obtained at a glance making the driver unable to know how much getting closer the vehicle is to the next guidance point. In the case of a navigation apparatus incorporated on a motorcycle, in particular, a user is not able to frequently check a display screen. For this reason, with a vague feeling for distance, the user is not able to grasp information instantaneously and thus may deviate from the guided route, posing another problem.

### Means for Solving Problem

To solve the problems above and achieve an object, a navigation apparatus according to the invention of claim 1 provides guidance along a route to a destination using a guidance image on which plural guidance signs, respectively indicative of a guidance direction at a guidance point, are arranged in order of proximity to a current point. The navigation apparatus includes a setting unit that preliminarily sets a first given distance from the current point; an extracting unit that extracts a given guidance point on the route; a calculating unit that calculates a distance from the current point to the given guidance point extracted by the extracting unit; and a display control unit that when the distance to the given guidance point calculated by the calculating unit becomes equal to or less than the first given distance, changes a color of a guidance sign at the guidance point to a color different from an current display color.

A navigation method according to the invention of claim 17 is a method for a navigation apparatus that provides guidance along a route to a destination using a guidance image on which plural guidance signs, respectively indicative of a guidance direction at a guidance point, are arranged in order of proximity to a current point. The navigation method includes extracting a given guidance point on the route; calculating a distance from the current point to the given guidance point extracted at the extracting; and controlling display, when the distance to the given guidance point calculated at the calculating becomes equal to or less than the first given distance, such that a color of a guidance sign at the guidance point changes to a color different from an current display color.

A navigation program according to the invention of claim 18 causes a computer to execute the navigation method according to claim 17.

A computer-readable recording medium according to the invention of claim 19 stores therein the navigation program according to claim 18.

### BRIEF DESCRIPTION OF DRAWINGS

FIG. 1 is a block diagram of an example of a functional configuration of a navigation apparatus according to an embodiment;

FIG. 2 is a flowchart of an example of a navigation procedure carried out by the navigation apparatus according to the embodiment;

FIG. 3 is a block diagram of an example of a hardware configuration of a navigation apparatus according to an example;

FIG. 4 is a flowchart of an example of a navigation process carried out by the navigation apparatus according to the example;

FIG. 5 is an explanatory diagram of an example of a display screen that appears when a nearest guidance point is at a location 701 m or more from the current position;

FIG. 6 is an explanatory diagram of an example of a display screen that appears when the nearest guidance point is at a location 700 m or less from the current position;

FIG. 7 is an explanatory diagram of an example of a display screen that appears when the nearest guidance point is at a location 300 m or less from the current position;

FIG. 8 is an explanatory diagram of an example of a detailed map screen that appears when the nearest guidance sign is selected;

FIG. 9 is an explanatory diagram of an example of a guidance image to which time information is added;

FIG. 10 is an explanatory diagram of an example of a guidance image on which the number of traffic signals between guidance signs is added;

FIG. 11 is an explanatory diagram of an example of guidance images in the case of arranging guidance signs other than a nearest guidance sign on the side corresponding to a direction indicated by the nearest guidance sign;

FIG. 12 is an explanatory diagram of an example of guidance images in the case of arranging guidance signs other than a nearest guidance sign on the side corresponding to a direction indicated by the nearest guidance sign;

FIG. 13 is an explanatory diagram of an example of guidance images in the case of arranging guidance signs according to the direction indicated the guidance signs, respectively;

FIG. 14 is an explanatory diagram of an example of guidance images in the case of arranging guidance signs according to the direction indicated the guidance signs, respectively;

FIG. 15 is an explanatory diagram of an example of guidance images where all displayed guidance signs are regarded as a single route;

FIG. 16 is an explanatory diagram of an example of guidance images where all displayed guidance signs are regarded as a single route;

FIG. 17 is an explanatory diagram of an example of guidance images where the nearest guidance sign indicating a straight direction appears as an animated image;

FIG. 18 is an explanatory diagram of an example of guidance images where the nearest guidance sign indicating a straight direction appears as an animated image;

FIG. 19 is an explanatory diagram of an example of guidance images where the nearest guidance sign indicating a left-turn direction appears as an animated image;

FIG. 20 is an explanatory diagram of an example of guidance images where the nearest guidance sign indicating a left-turn direction appears as an animated image;

FIG. 21 is an explanatory diagram of an example of display of a guidance image where a guidance sign is displayed three-dimensionally;

FIG. 22 is an explanatory diagram of an example of guidance signs displayed in other shapes; and

FIG. 23 is an explanatory diagram of an example of guidance signs displayed in other shapes.

### EXPLANATIONS OF LETTERS OR NUMERALS

100 navigation apparatus
101 setting unit
102 extracting unit
103 calculating unit
104 display control unit
105 display unit
106 acquiring unit
107 mode setting unit
108 receiving unit
300 navigation apparatus

### BEST MODE(S) FOR CARRYING OUT THE INVENTION

Preferred embodiments of a navigation apparatus, a navigation method, navigation program, and recording medium according to the present invention will be explained with reference to the accompanying drawings.

### Embodiment

### Functional Configuration of Navigation Apparatus

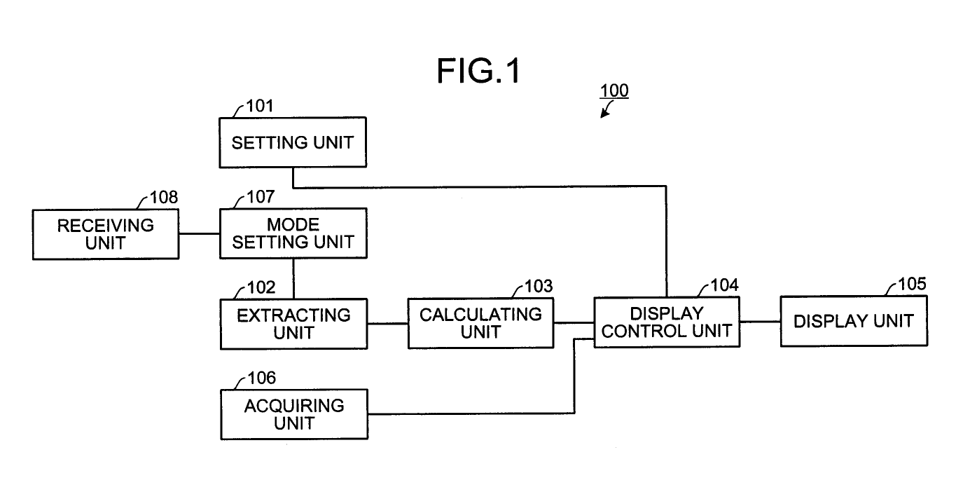

A functional configuration of a navigation apparatus 100 according to an embodiment of the present invention will be described. FIG. 1 is a block diagram of an example of a functional configuration of the navigation apparatus 100 of the embodiment. The navigation apparatus 100 provides guidance along a route to a destination, using a guidance image on which plural guidance signs each indicating a guidance direction at each given guidance point are arranged in the order of proximity to the current point.

Given guidance points include every point at which guidance is provided in the directions of right/left turns, travel straight ahead, etc., for a point at which guidance is provided for the direction of right/left turns exclusive of travel straight ahead, a point that is not recorded in travel history, and a point at which guidance setting is made by the user. A route to a destination may be a route retrieved by a searching unit incorporated in the navigation apparatus 100 or may be a route manually set by the user.

A guidance sign indicates a guidance direction at a guidance point, and is displayed, herein, using an arrow indicating the right direction, the left direction, or the straight direction. Guidance signs are, herein, displayed at three points, but the number of guidance signs is not particularly specified as long as the guidance signs are displayed at two or more points. A guidance image is an image that exhibits a plurality of such arranged guidance signs (arrows) and that is displayed in an area formed to be separated from an area for a map image. The guidance image is displayed side by side with the map image on a display screen herein, but the guidance image may be displayed alone.

In FIG. 1, the navigation apparatus 100 includes a setting unit 101, an extracting unit 102, a calculating unit 103, a display control unit 104, a display unit 105, an acquiring unit 106, a mode setting unit 107, and a receiving unit 108.

The setting unit 101 sets a first given distance from the current point in advance. The first given distance is set to display a guidance sign in a different color, the first given distance being set as a distance to a given guidance point (e.g., 300 m). The first given distance is a value preset as a default value herein, but may be changed appropriately by the user.

The extracting unit 102 extracts a given guidance point on a route. The extracting unit 102, herein, extracts position information concerning the guidance point. The extracting unit 102 carries out extraction in proper timing when a route searching unit, which is not depicted, retrieves a route or guidance along the route is in progress, or when a route is set manually by the user.

The calculating unit 103 calculates the distance from the current point to a given guidance point extracted by the extracting unit 102. The calculating unit 103 calculates the distance from the current point to each guidance point in carrying out the calculation for plural guidance points corresponding to guidance signs.

When the distance to a given guidance point calculated by the calculating unit 103 becomes equal to or less than the first given distance, the display control unit 104 changes the color of a guidance sign at the guidance point to a color different from the original display color. The display control unit 104 carries out such control not only on the nearest guidance sign but also on other guidance signs. When the distance to a guidance point becomes equal to or less than the first given distance, therefore, the display control unit 104 changes the color of the respective guidance sign at the guidance point to a color different from the current display color. In other words, the display control unit 104 may display multiple guidance signs on a guidance image in colors that have been changed.

It is preferable for the color of a guidance sign at the time that the distance to the corresponding guidance point becomes equal to or less than the first given distance be a conspicuous color, compared to the current display color of the guidance sign. For example, if the current display color is blue, the color of the guidance sign should preferably be changed to red, etc. A guidance sign area for which the color is to be changed is, for example, the background of an arrow. Depending on the form of the guidance sign, however, the color of the arrow itself, which indicates a guidance direction, may be changed.

The display unit 105, under the control of the display control unit 104, displays a guidance image exhibiting guidance signs arranged thereon. The display unit 105 is, herein, provided as a display.

In this embodiment, the setting unit 101 may set a second given distance that is a greater distance from the current point than the first given distance. The second given distance is set as the distance that lets the user know that the user is, to some extent, approaching a guidance point (e.g., 700 m). The second given distance is a value preset as a default value herein, but may be changed appropriately by the user.

In this case, when the distance to a guidance point calculated by the calculating unit 103 becomes equal to or less than the second given distance, the display control unit 104 changes the display form of a guidance sign at the guidance point to a display form different from the current display form. The display form of the guidance sign at the time of the distance to the corresponding guidance point becoming equal to or less than the second given distance includes, for example, display in a different color, display in a blinking state, and adding to the guidance sign, information indicative of the details of the guidance point, to be described later.

It is desirable in this embodiment that the display control unit 104 makes the display form of a guidance sign at the time that the distance to the corresponding guidance point becomes equal to or less than the second given distance different from the display form of a guidance sign at the time that the distance to the corresponding guidance point becomes equal to or less than the first given distance. Making display forms different from each other means, for example, making the display forms different in color or in a blinking pattern. The guidance sign at the time that the distance to the guidance point becomes equal to or less than the first given distance and the guidance sign at the time that the distance to the guidance point becomes equal to or less than the second given distance are made different from each other in such display forms as color and blinking pattern.

Specific examples of the display form of the guidance sign at the time that the distance to the guidance point becomes equal to or less than the second given distance and the display form of the guidance sign at the time that the distance to the guidance point becomes equal to or less than the first given distance are as follows. At the time that the distance to the guidance point becomes equal to or less than the second given distance, information indicative of the details of the guidance point is added to the guidance sign; and at the time that the distance to the guidance point becomes equal to or less than the first given distance, information indicative of the details of the guidance point is added to the guidance sign, the color of which has been changed. Information indicative of the details of a guidance point is, for example, information of an intersection name. When an intersection has no name, nothing may be displayed or a message indicating that the intersection has no name may be displayed.

In this embodiment, the display control unit 104 may arrange all guidance signs displayed on the guidance image on the side corresponding to the direction indicated by the nearest guidance sign (hereinafter “nearest guidance sign”). Specifically, for example, if the nearest guidance sign indicates a left turn, the display control unit 104 arranges the next guidance sign and the subsequent guidance sign on the left side of the guidance image. If the nearest guidance sign indicates travel straight ahead, subsequent guidance signs are arranged at the center of the guidance image. If the nearest guidance sign indicates a right turn, subsequent guidance signs are arranged on the right side of the guidance image.

In this embodiment, the display control unit 104 may arrange each guidance sign displayed on the guidance image according to the direction indicated by each guidance sign. This is a configuration in which subsequent guidance signs are not arranged on the side corresponding to the direction indicated by the nearest guidance sign in the above manner but each guidance sign is arranged and displayed on the side corresponding to the direction indicated by the guidance sign. Specifically, for example, if the nearest guidance sign indicates a left turn and the subsequent guidance sign indicates travel straight ahead, the nearest guidance sign is displayed on the left side of the guidance image, while the subsequent guidance sign is displayed at the center of the guidance image.

In this embodiment, the display control unit 104 may display multiple guidance signs on the guidance image in such a way that a guidance sign is displayed in a larger size as the distance from the current point decreases. In this configuration, a guidance sign indicating proximity to a guidance point and disposed closer to the current point is displayed in a larger size.

In this embodiment, the display control unit 104 may display multiple guidance signs on the guidance image in such a way that a guidance sign is displayed to appear more three-dimensional as the distance from the current point decreases. Display of the guidance sign three-dimensionally means giving the guidance sign a height component. For example, when the guidance sign is displayed as a three-dimensional form, the guidance sign is displayed more three-dimensionally as the distance from the current point decreases. Specifically, for example, the display control unit 104 displays the guidance sign three-dimensionally as a stack of guidance signs, and increases the thickness of the displayed guidance sign as the distance from the current point decreases. In this configuration, a guidance sign indicating proximity to a guidance point and disposed closer to the current point is displayed more three-dimensionally.

In this embodiment, the display control unit 104 may display multiple guidance signs on the guidance image together with additional information indicative of the distance from the corresponding guidance sign to the current point.

In this embodiment, the display control unit 104 may display multiple guidance signs on the guidance image together with additional information indicative of the time of arrival to the guidance point corresponding the guidance sign. An arrival time is calculated by using a specified speed or legal speed on a guide route, probe information or information from VICS (registered trademark) on another vehicle's traveling time, or a speed based on the travel history of the vehicle of the user, along the guide route.

In this embodiment, the acquiring unit 106 is an arbitrary constituent element. The acquiring unit 106 acquires point information concerning traffic signals along a route to a destination. In this case, the display control unit 104 carries out control to display the number of traffic signals to be passed during travel between guidance points, using the point information concerning traffic signals acquired by the acquiring unit 106. The number of traffic signals, herein, may be displayed by enumerating figures or by displaying illustrations or symbols of traffic signals in a quantity equivalent to the number of traffic signals.

In this embodiment, the display control unit 104 may cause a nearest guidance sign to appear as an animated image in the direction indicated by the nearest guidance sign. An animated image is created by gradually moving a still image. Causing the nearest guidance sign to appear as an animated image means causing the nearest guidance sign to appear to be in motion on the display screen on which the nearest guidance sign is not displayed yet. Such appearance as an animated image may be made once, or may be made several times until the vehicle of user passes the guidance point indicated by the nearest guidance sign.

It is desirable in this embodiment that a nearest guidance sign be displayed as a touch panel. In this case, when the nearest guidance sign displayed as the touch panel is selected by the user, the display control unit 104 carries out control to display a detailed map screen of the guidance point indicated by the nearest guidance sign on the entire area of the display screen. The detailed map screen is, for example, the screen depicting an intersection name, lane, enlarged view of an intersection, etc.

In this configuration, the detailed map screen appearing on the entire area of the display screen is desirably displayed as a touch panel. In this case, when the detailed map screen displayed as the touch panel is selected by the user, the display control unit 104 carries out control to display a screen on which a guidance image is used. This means that the user selection of the detailed map screen displayed as the touch panel sets the screen back to the original screen.

In this embodiment, the mode setting unit 107 and the receiving unit 108 are arbitrary constituent elements. The mode setting unit 107 sets a guidance image mode for providing guidance along a route by using a guidance image and a normal mode for providing guidance along a route, using a map screen alone without the use of a guidance image. The receiving unit 108 receives a selected mode set by the mode setting unit 107. A selected mode is received, for example, at startup of the navigation apparatus. The guidance image mode is, herein, a guidance mode for a motorcycle. When the user selects the guidance image mode, guidance along a route is provided with the use of a guidance image and display based on the control by the display control unit 104 is carried out.

(Navigation Procedure by Navigation Apparatus)

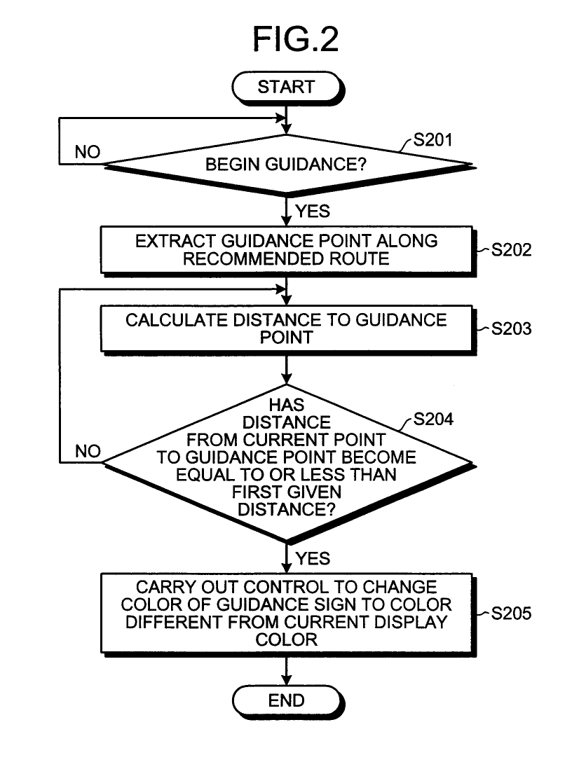

A navigation procedure by the navigation apparatus 100 will be described with reference to FIG. 2. FIG. 2 is a flowchart of an example of the navigation procedure by the navigation apparatus 100 of this embodiment.

As depicted in the flowchart of FIG. 2, the navigation apparatus 100 remains in a stand-by state until a destination is set to initiate guidance (step S201: NO). When guidance is initiated (step S201: YES), a guidance point on a recommended route is extracted (step S202). The route from which the guidance point is extracted at step S202 is not limited to a recommended route obtained by route searching and may be a route manually set by the user. Guidance point extraction may be carried out following route searching that is executed prior to step S201.

The distance to the guidance point is then calculated (step S203). Subsequently, whether the distance from the current point to the guidance point is the first given distance is determined (step S204). At step S204, the procedure returns to step S203 until the distance from the current point to the guidance point has become equal to or less than the first given distance (step S204: NO).

At step S204 if it is determined that the distance from the current point to the guidance point has become equal to or less than the first given distance (step S204: YES), control is carried out to change the display color of the guidance sign to a color different from the current display color (step S205), after which a series of operations comes to an end.

As described above, according to the navigation apparatus 100 of this embodiment, when the distance to a guidance point has become equal to or less than the first given distance, control is carried out to change the color of a guidance sign at the guidance point to a color different from the current display color. This enables the user to have a sense for distance and to know at a glance how much closer the user is to the next guidance point. Even if the user is unable to frequently check the display screen, therefore, the user is allowed to grasp information instantaneously and to follow the guide route.

If the second given distance, which is longer than the first given distance, is set via the setting unit 101, when the distance to a guidance point becomes equal to or less than the second given distance, the display form of a guidance sign at the guidance point is changed to a display form different from the current display form, enabling the user to know prior to approaching the first given distance that the user is coming closer to the guidance point.

If the display form of a guidance sign at the time that the distance to the corresponding guidance point becomes equal to or less than the second given distance is made different from the display form of the guidance sign at the time that the distance to the corresponding guidance point becomes equal to or less than the first given distance, the user is able to know that the user is coming gradually closer to the guidance point and to clearly see that the distance to the guidance point has become equal to or less than the first given distance.

If information indicating details of a guidance point is additionally displayed when the distance to the guidance point has become equal to or less than the second given distance and information indicating details of the guidance point is additionally displayed together with the corresponding guidance sign whose color has been changed when the distance to the guidance point has become equal to or less than the first given distance, the user is able to know the intersection name, etc., to accurately grasp the location of a guide intersection.

Arranging all guidance signs on the side corresponding to a direction indicated by a nearest guidance sign gives a guidance image itself directionality. This enables display of a screen that is easy for the user to understand instantaneously.

Arranging each guidance sign displayed on the guidance image according to the direction indicated by each guidance sign allows the user to know at a glance which direction to proceed in order to reach each guidance point indicated by the corresponding guidance sign.

If multiple guidance signs are displayed on the guidance image in such a way that a guidance sign is displayed in a larger size as the distance from the current point decreases, a sense for the distance to each guidance point becomes more perceivable.

If multiple guidance signs are displayed on the guidance image in such a way that a guidance sign is displayed more three-dimensionally as the distance from the current point decreases, a sense for the distance to each guidance point becomes more perceivable. Particularly, if the guidance sign is displayed three-dimensionally in a display form of a stack of guidance signs and the thickness of the displayed guidance sign is increased as the distance from the current point decreases, three-dimensionality is expressed easily to give a sense for the distance to each guidance point.

If multiple guidance signs are displayed on the guidance image together with additional information of the respective distances from the current point to the guidance signs, the user is able to grasp the distance to a guidance point.

If multiple guidance signs are displayed on the guidance image together with additional information of the arrival time to the guidance point that corresponds to the guidance sign, the user is able obtain detailed information concerning the guidance point.

If the number of traffic signals to be passed during travel between guidance points is displayed between the guide signs corresponding to the guidance points, the user is able to grasp the distance to a guidance point, based on the number of traffic signals.

If the nearest guidance sign is caused to appear as an animated image in a direction indicated by the nearest guidance sign, the direction indicated by the nearest guidance sign is presented in a motion display, enabling the user to grasp the direction of the corresponding guidance point more easily.

If the nearest guidance sign is displayed as a touch panel and a detailed map screen of the guidance point indicated by the nearest guidance sign is displayed on the entire area of the display screen when the nearest guidance sign displayed as the touch panel is selected by the user, for example, the user is able to easily touch the nearest guidance sign displayed on a large area of the display screen to see the detailed map screen even if the user is driving a motorcycle with his or her gloves on.

If a detailed map screen appearing on the entire area of the display screen is displayed as a touch panel and a screen on which a guidance image is used is displayed when the detailed map screen displayed as the touch panel is selected by the user, the user is able to easily touch the detailed map screen appearing on the entire area of the display screen and return the screen to the screen displaying the guidance image even if the user is driving a motorcycle with his or her gloves on.

If the guidance image mode for guidance along a route, using a guidance image and the normal mode for guidance along a route, using a map screen alone without the use of a guidance image are set, e.g., the user is able to set a mode according to the user's purpose, such as using the navigation apparatus when driving a motorcycle. When the user drives a passenger car, the navigation apparatus can be operated in the normal mode.

### Example

An example of the present invention will be described. The following description relates to an example of application of the navigation apparatus of the present invention as a navigation apparatus mounted on a motorcycle.

(Hardware Configuration of Navigation Apparatus)

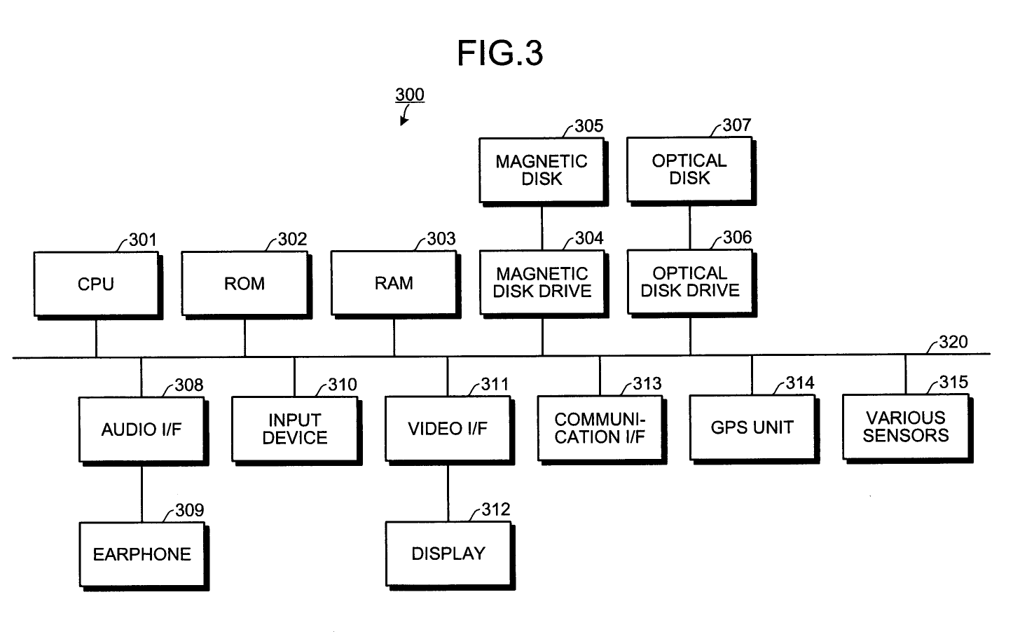

A hardware configuration of a navigation apparatus 300 according to an example will be described with reference to FIG. 3. FIG. 3 is a block diagram of an example of a hardware configuration of the navigation apparatus 300 according to the example.

The navigation apparatus 300 of FIG. 3 is mounted on a motorcycle functioning as a mobile object. Specifically, for example, the navigation apparatus 300 is housed in a tank bag, etc., disposed on a fuel tank of the motorcycle in such a way that a display screen of the navigation apparatus 300 is visible to a user via a transparent sheet on the surface of the tank bag. The location of the navigation apparatus 300 is not limited to the tank bag. The navigation apparatus 300 may be attached directly to a dedicated stay that is disposed around the handlebars.

The navigation apparatus 300 includes a CPU 301, a ROM 302, a RAM 303, a magnetic disk drive 304, a magnetic disk 305, an optical disk drive 306, an optical disk 307, an audio I/F (interface) 308, an earphone 309, an input device 310, a video I/F 311, a display 312, a communication I/F 313, a GPS unit 314, and various sensors 315, respectively connected through a bus 320.

The CPU 301 governs overall control of the navigation apparatus 300. The ROM 302 and/or a non-volatile memory such as a flash ROM, etc. store therein various programs such as a boot program, a current position calculating program, a route search program, a route guidance program, and a navigation program. The RAM 303 is used as a work area of the CPU 301.

The current position calculating program calculates the current position of the vehicle (current position of the navigation apparatus 300) based on, for example, output information from the GPS unit 314 and the various sensors 315, which will be described later.

The route search program searches for an optimal route from a starting point to a destination using map data, etc., recorded on the magnetic disk 305. The optimum route is the shortest (fastest) route to the destination, the route best meeting a condition specified by the user, etc. Besides the destination, a route to a point of interest or a rest stop may be searched for. A retrieved guide route is output to the audio I/F 308 and the video I/F 311 via the CPU 301.

The route guidance program generates real-time route guidance information based on information of a guide route retrieved by the route search program, information of the current vehicular position calculated by the current position calculating program, and map data read out from the magnetic disk 305. The generated route guidance information is output to the audio I/F 308 and the video I/F 311 via the CPU 301.

The navigation program is a program that provides guidance along a recommended route to a destination according to the set mode, using a guidance image displaying multiple guidance signs, each indicating a guidance direction at each guidance point and each arranged closer to the current point in the order of proximity thereto. Specifically, with this program, when the distance from the current point to a guidance point becomes equal to or less than the second given distance (e.g., 700 m) set in advance on the RAM 303, etc., an intersection name is added to a guidance sign at the guidance point, and when the distance from the current point becomes equal to or less than the first given distance (e.g., 300 m), the color of the guidance sign at the guidance point is changed to a color different from the current display color (e.g., changed from blue to red).

Modes to be set include the normal mode for displaying a map screen on the entire area of the display screen and a motorcycle navigation mode using a guidance image (which is equivalent to the guidance image mode). When the motorcycle navigation mode is set, the navigation program is executed.

The magnetic disk drive 304 controls the reading and the writing of data with respect to the magnetic disk 305 under the control of the CPU 301. The magnetic disk 305 stores therein the data written under the control of the magnetic disk drive 304. An HD (hard disk) or FD (flexible disk), may be used as the magnetic disk 305, for example.

The optical disk drive 306 controls the reading and the writing of data with respect to the optical disk 307 under the control of the CPU 301. The optical disk 307 is a removable recording medium from which data is read out under the control of the optical disk drive 306. A writable recording medium may be utilized for the optical disk 307. The removable recording medium may be a medium other than the optical disk 307, such as an MO, a memory card, etc.

The audio I/F 308 is connected to the earphone 309. The audio I/F 308 and the earphone 309 are interconnected via a connection cord, but may be interconnected through short-range radio communication. The earphone 309 emits sounds. The input device 310 is a touch panel, but may be provided as a remote controller having multiple keys for entering characters, numerical values, various instructions, etc., and may be an operation button.

The video I/F 311 is connected to the display 312. Specifically, the video I/F 311 is made up of, for example, a graphic controller that generally controls the display 312, a buffer memory such as VRAM (Video RAM) that temporarily records immediately displayable image information, and a control IC that controls the display 312, based on image data output from a graphic controller.

The display 312 displays icons, cursors, menus, windows, or various data such as characters and images. For example, a CRT, a TFT liquid crystal display, a plasma display, etc., may be employed as the display 312. The display 312 is provided, for example, near the dash board of the vehicle.

The communication I/F 313 is wirelessly connected to a network and functions as an interface between the navigation apparatus 300 and the CPU 301. The communication I/F 313 is further connected wirelessly to a communication network, such as the Internet, and functions as an interface between the CPU 301 and the communication network.

The communication network includes LANs, WANs, public line networks, portable telephone networks, etc. Specifically, the communication I/F 313, for example, is configured by an FM tuner, a VICS (Vehicle Information and Communication System)/beacon, etc. and acquires traffic information such as that distributed by a VICS center concerning traffic congestion, traffic laws and regulations, etc. VICS is a registered trademark.

If DSRC (Dedicated Short Range Communication) is executed, the communication I/F 313 includes a vehicular radio device that communicates with a radio device set on the road through two-way radio communication. In such a case, the communication I/F 313 is capable of acquiring various types of information, such as the information described above and traffic information.

The GPS unit 314 receives signals from GPS satellites and outputs information indicative of the current position of the vehicle. The information output from the GPS unit 314 is used when the CPU 301 calculates the current position of the vehicle along with values output from the various sensors 315 described hereinafter. The information indicative of the current position is information specifying a point with respect to the map information, for example, latitude/longitude and altitude.

The various sensors 315 include a speed sensor, an acceleration sensor, and an angular-velocity sensor and output information that enables determination of position and behavior of the vehicle. The values output from the various sensors 315 are used by the CPU 301 for calculating the current position of the vehicle and measuring changes in speed and direction. Further, if the navigation apparatus 300 is portable, the various sensors may be omitted.

The setting unit 101, the extracting unit 102, the calculating unit 103, the display control unit 104, the display unit 105, the acquiring unit 106, the mode setting unit 107, and the receiving unit 108 included in the navigation apparatus 100 depicted in FIG. 1 are implemented by an execution of given programs to control the units of the navigation apparatus 300, where the CPU 301 uses programs and data recorded on the ROM 302, and the non-volatile memory including the RAM 303, the magnetic disk 305, the optical disk 307, etc., of the navigation apparatus 300 depicted in FIG. 3 to execute the given programs.

In other words, the navigation apparatus 300 of the example executes the navigation program recorded on the non-volatile memory or the ROM 302 serving as a recording medium in the navigation apparatus 300 to implement the functions of the navigation apparatus 100 depicted in FIG. 1 in the procedure of the navigation process depicted in FIG. 2.

(Example of Navigation Process Carried Out by Navigation Apparatus)

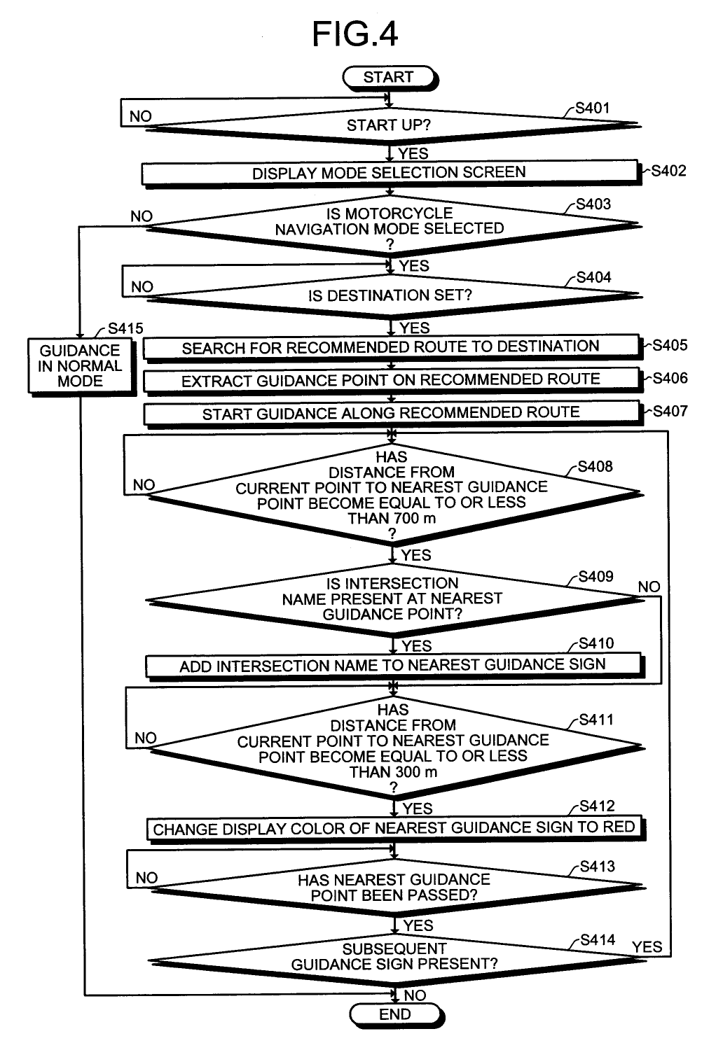

An example of a navigation process carried out by the navigation apparatus 300 of this working example will be described with reference to FIG. 4. FIG. 4 is a flowchart of an example of the navigation process carried out by the navigation apparatus 300 of the example.

As depicted in FIG. 4, the navigation apparatus 300 remains in a stand-by state until startup (step S401: NO). Upon startup (step S401: YES), the navigation apparatus 300 displays a mode selection screen (step S402). Timing of the display of the mode selection screen is not limited to the time of startup. The mode selection screen may be displayed by selecting a mode setting icon or may be displayed by selecting a function setting change menu on a menu screen, etc.

Subsequently, whether the motorcycle navigation mode is selected is determined (step S403). If it is determined that the motorcycle navigation mode has been selected (step S403: YES), mode transition is made to the motorcycle navigation mode, and the stand-by state continues until a destination is set based on input from the user (step S404: NO).

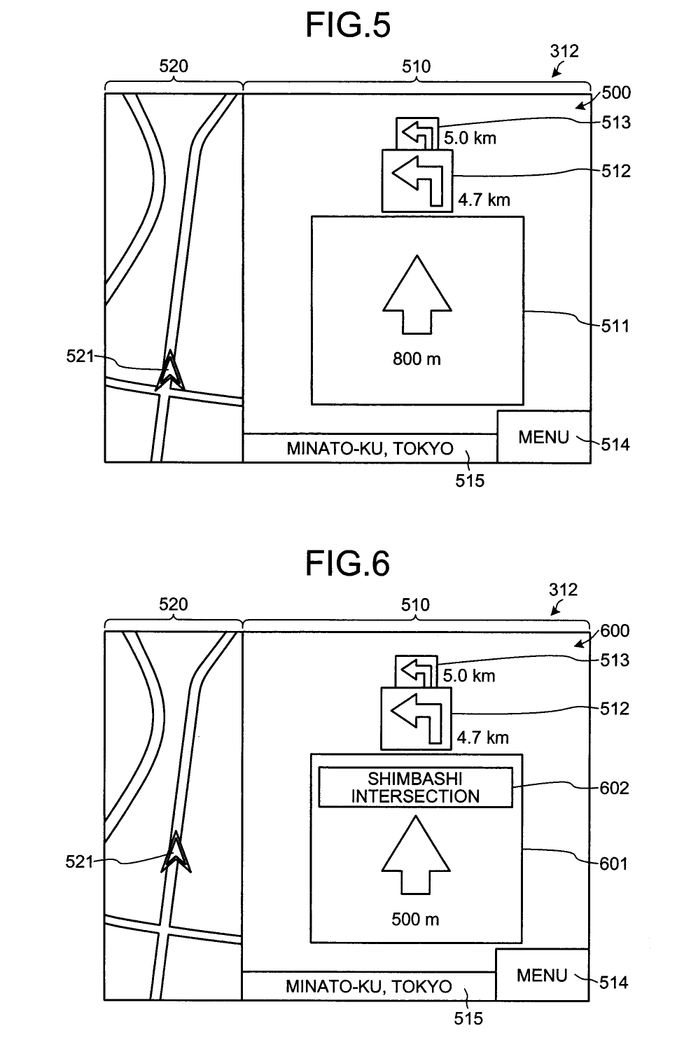

When the destination is set at step S404 (step S404: YES), a recommended route to the destination is retrieved (step S405). Following this, a guidance point on the recommended route is extracted (step S406), and then guidance along the recommended route is started (step S407). It is assumed at this point in time that, from the current point, no guidance point is present within a range of 700 m or less, set as the second given distance. Details concerning the display screen at step S407 will be described later with reference to FIG. 5, the display screen depicting all guidance signs in blue.

Subsequently, the stand-by state continues until the distance from the current point to a guidance point (“nearest guidance point”) indicated by a guidance sign (“nearest guidance sign”) located nearest to the current point becomes equal to or less than 700 m (step S408: NO). When the distance from the current point to the nearest guidance point becomes equal to or less than 700 m (step S408: YES), whether an intersection name is present at the nearest guidance point is determined (step S409).

If the intersection name at the nearest guidance point is determined to be present (step S409: YES), the intersection name is added to the nearest guidance sign (step S410). Details concerning the display screen at step S410 will be described later with reference to FIG. 6, the display screen depicting all guidance signs blue. The stand-by state then continues until the distance from the current point to the nearest guidance point becomes equal to or less than 300 m that is the distance set as the first given distance (step S411: NO). If the intersection name at the nearest guidance point is determined to be absent at step S409 (step S409: NO), the process flow proceeds to step S411.

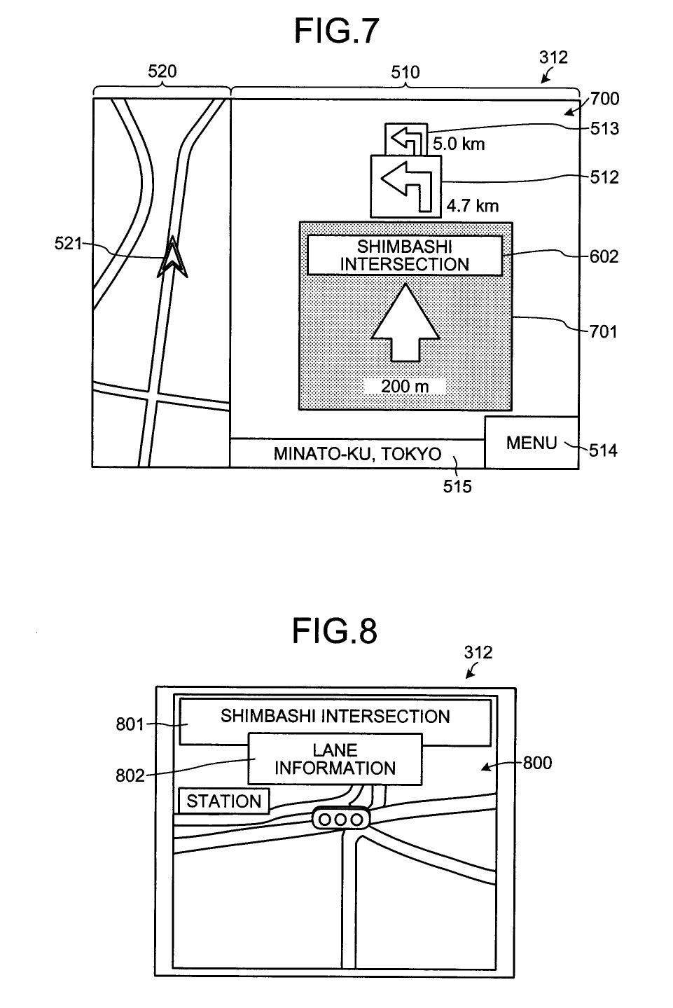

If the distance from the current point to the nearest guidance point becomes equal to or less than 300 m at step S411 (step S411: YES), the display color of the nearest guidance sign is changed to red (step S412). Details concerning the display screen at step S412 will be described later with reference to FIG. 7. Subsequently, the stand-by state continues until the nearest guidance point is passed (step S413: NO).

When the nearest guidance point is passed (step S413: YES), whether a subsequent guidance sign is present is determined (step S414). If the presence of a subsequent guidance sign is determined (step S414: YES), the process flow proceeds to step S408. If a subsequent guidance sign is determined to not be present (step S414: NO), a series of operations comes to an end. If the motorcycle navigation mode is not selected at step S403 (step S403: NO), guidance in the normal mode is executed (step S415), and the series of operations comes to an end.

If the nearest guidance point is present within the range of 700 m or less from the current point at the start of guidance along the recommended route at step S407, an intersection name is added to change the display form of the guidance sign corresponding to the nearest guidance point. While the color of the nearest guidance sign alone is changed to red at step S412, if a guidance point indicated by a guidance sign displayed next is also within the range of 300 m or less, the color of the guidance sign displayed next is also changed to red.

(Example of Display Screen at Time of Guidance Along Route)

Examples of display screens appearing on the display 312 at the time of guidance along a route will be described with reference to FIGS. 5 to 8. FIG. 5 is an explanatory diagram of an example of a display screen that appears when a nearest guidance point is at a location 701 m or more from the current position.

In FIG. 5, a display screen 500 appearing on the display 312 includes a guidance image 510 and a map image (map screen) 520. The guidance image 510 displays a nearest guidance sign 511 indicating the nearest guidance point, a subsequent guidance sign (hereinafter “second guidance sign”) 512, a guidance sign 513 following the second guidance sign 512 (hereinafter “third guidance sign”), a menu button 514, and the current position display 515.

Each of the guidance signs 511 to 513 indicates a guidance direction at a corresponding guidance point. Each of the guidance signs 511 to 513 is colored blue, and accompanies display of the distance from the current position. The size of each of the guidance signs 511 to 513 corresponds to each displayed distance. Specifically, the shorter the distance from the current point is, the larger the displayed guidance sign is.

When the menu button 514 is selected by the user, the display screen turns to a menu screen. The current position display 515 is the display of the name of a location equivalent to a vehicle current position 521 displayed on the map image 520. On this display screen 500, when the nearest guidance point becomes 700 m or less distant from the current point 521, the display screen 500 turns to a display screen 600 of FIG. 6.

FIG. 6 is an explanatory diagram of an example of a display screen that appears when the nearest guidance point is at a location 700 m or less from the current position. On the display screen 600 of FIG. 6, a nearest guidance sign 601 indicates that the nearest guidance point is 500 m from the current position 521. The nearest guidance sign 601 accompanies display of an intersection name 602, having a display form different from that of the second guidance sign 512 and that of the third guidance sign 513.

The guidance signs 601, 512, and 513 are each colored blue. The display color of the nearest guidance sign 601 may be changed to, for example, yellow. When a guidance point indicated by the second guidance sign 512 is at a location 700 m or less distant from the current position 521, the intersection name 602 is displayed at the second guidance sign 512. On this display screen 600, when the nearest guidance point becomes 300 m or less from the current position 521, the display screen 600 turns to a display screen 700 of FIG. 7.

FIG. 7 is an explanatory diagram of an example of a display screen that appears when the nearest guidance point is at a location 300 m or less from the current position 521. As depicted in FIG. 7, the nearest guidance sign 701 indicates that the nearest guidance point is 200 m from the current position 521. The nearest guidance sign 701 is colored in red as a result of changing the color from the current display color of blue, which means the nearest guidance sign 701 has a color different from the current display color. The nearest guidance sign 701 is different in color from the nearest guidance sign 601 of FIG. 6, thus different in display form.

On the display screen 700, if the guidance point indicated by the second guidance sign 512 is also at a location 300 m or less distant from the current point, the display color of the second guidance sign 512 is also changed to red. The nearest guidance sign 511 of FIG. 5, the nearest guidance sign 601 of FIG. 6, and the nearest guidance sign 701 of FIG. 7 are each displayed as a touch panel, so that touching any one of these nearest guidance signs 511, 601, and 701 turns the display screen 700 to a detailed map screen 800 of FIG. 8.

FIG. 8 is an explanatory diagram of an example of a detailed map screen that appears when the nearest guidance sign is selected. As depicted in FIG. 8, the detailed map screen 800 on the display 312 displays an intersection name 801 and lane information 802 on a map. The lane information 802 is, for example, the information indicative of the direction of travel through each lane in one-way traffic with multiple lanes. The detailed map screen 800 is displayed in the entire screen area as a touch panel. Touching the detailed map screen 800 sets it back to the original screen, that is, changes the detailed map screen 800 to the display screen 500 of FIG. 5, the display screen 600 of FIG. 6, or the display screen 700 of FIG. 7.

According to the navigation apparatus 300, when the distance to a guidance point becomes equal to or less than the first given distance (300 m), the color of a guidance sign at the guidance point is changed to a color (red) different from the current display color (blue). This enables the user to have a sense for distance and to know at a glance how much closer the user is to the next guidance point. Even if the user is unable to frequently check the display screen, therefore, the user is able to grasp information instantaneously to follow a route along the guide route.

The second given distance (700 m) is set, and when the distance to a guidance point becomes equal to or less than 700 m, information of an intersection name is added to the corresponding guidance sign to change its display form to a display form different from the current display form. This allows the user to know prior to approaching the first given distance that the user is coming closer to the guidance point.

The color of a guidance sign at the time that the distance to the corresponding guidance point becomes equal to or less than 700 m is made different from the color of the guidance sign at the time that the distance to the corresponding guidance point becomes equal to or less than 300 m. This enables the user to know that the user is coming gradually closer to the guidance point and to clearly see that the guidance point is now just ahead.

Information indicative of the details of a guidance point, such as an intersection name, is additionally displayed when the distance to the guidance point has become equal to or less than 700 m, and the information concerning the intersection name is additionally displayed as the color of the corresponding guidance sign is changed to red when the distance to the guidance point has become equal to or less than 300 m. This enables the user to know the name of an intersection, etc., to accurately grasp the location of a guide intersection.

Multiple guidance signs are displayed on a guidance image in such a way that a guidance sign is displayed in a larger size as the distance from the current point decreases. This makes a feeling for the distance to each guidance point more perceivable.

Multiple guidance signs are displayed on a guidance image together with additional information of the respective distances from the current point to the guidance signs. As a result, the user is able to grasp the distance to each guidance point.

The nearest guidance sign is displayed as a touch panel, and when the nearest guidance sign displayed as the touch panel is selected by the user, a detailed map screen of a guidance point indicated by the nearest guidance sign is displayed on the entire area of the display screen. Even if the user is wearing gloves, therefore, the user is able to easily touch the nearest guidance sign displayed on a wide area of the display screen and see the detailed map screen.

A detailed map screen appearing on the entire area of the display screen is displayed as a touch panel, and when the detailed map screen displayed as the touch panel is selected by the user, a screen on which a guidance image is used is displayed. As a result, even if the user is wearing gloves, the user is able to easily touch the detailed map screen appearing on the entire area of the display screen to set the screen back to the screen displaying the guidance image.

The motorcycle navigation mode for guidance along a route, using a guidance image and the normal mode for guidance along a route, using a map screen alone without the use of a guidance image are set. This enables mode setting for a case of using the navigation apparatus when operating a motorcycle. The navigation apparatus can be operated in the normal mode when the user operates a passenger car.

According to this embodiment, a display form other than the display forms of the guidance image and guidance sign as described above may be adopted. Examples of display forms different from the display forms described so far will hereinafter be described in order.

(Example of Information Added to Guidance Image)

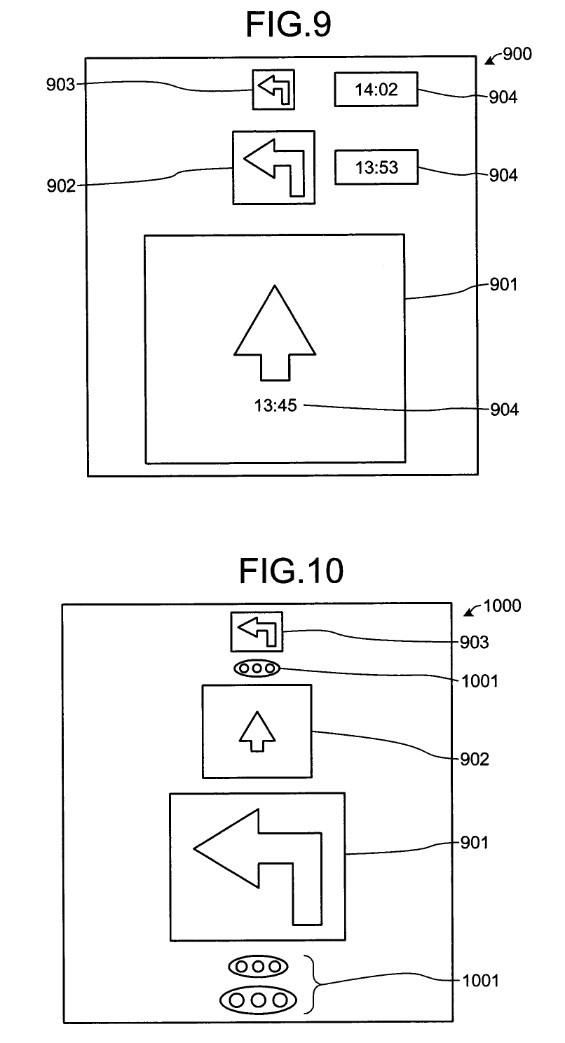

An example of information added to a guidance image at the time of guidance along a route will be described with reference to FIGS. 9 and 10. FIG. 9 is an explanatory diagram of an example of a guidance image to which time information is added. In FIG. 9, a guidance image 900 displays a nearest guidance sign 901, a second guidance sign 902, and a third guidance sign 903.

At each of the guidance signs 901, 902, and 903, each scheduled time 904 representing a time of arrival at each of the guidance signs 901, 902, and 903 is displayed. The distance from the current point may also be displayed together with the scheduled time 904. With this guidance image 900, the user is able to acquire detailed information of a guidance point.

FIG. 10 is an explanatory diagram of an example of a guidance image on which the number of traffic signals between guidance signs is added. In FIG. 10, a guidance image 1000 displays traffic signal symbols 1001 indicative of the number of traffic signals present between guidance signs. Aside from the symbol 1001, the number of traffic signals may be represented by text. Hence, the number of traffic signals may be expressed in such a way that “2 traffic signals” is displayed between the current point and the nearest guidance sign 901 while “1 traffic signal” is displayed between the second guidance sign 902 and the third guidance sign 903.

This guidance image 1000 allows the user to grasp the distance to a guidance point based on the number of traffic signals. The size of a traffic signal represented as the symbol 1001 may be determined according to distance, which means a traffic signal closer to the current position is displayed in a larger size.

(Example of Sign Arrangement on Guidance Image)

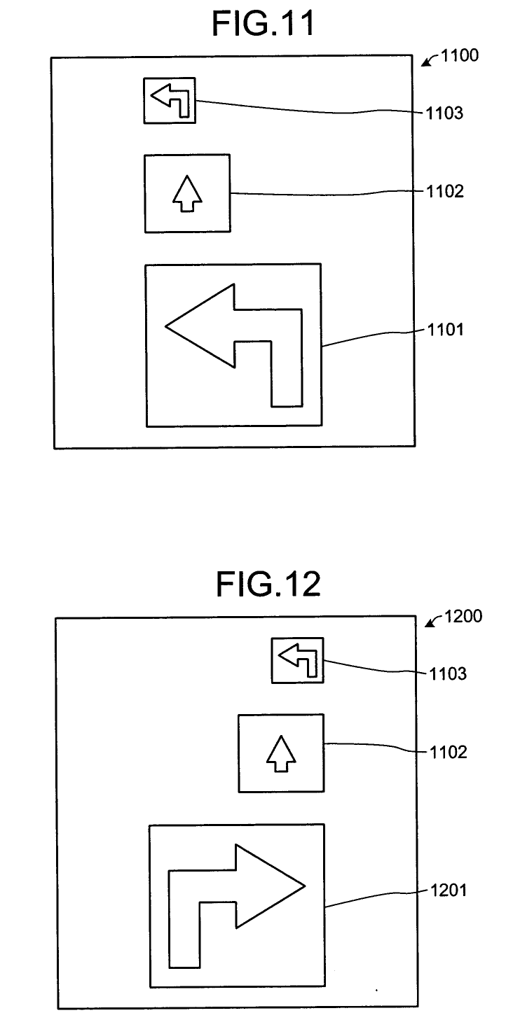

Examples of sign arrangement on a guidance image at the time of guidance along a route will be described with reference to FIGS. 11 to 16. FIGS. 11 and 12 are explanatory diagrams of examples of guidance images in the case of arranging guidance signs other than a nearest guidance sign on the side corresponding to a direction indicated by the nearest guidance sign. In FIG. 11, a nearest guidance sign 1101 displayed on a guidance image 1100 indicates a left-turn direction. A second guidance sign 1102 and a third guidance sign 1103 are arranged on the left according to the direction indicated by the nearest guidance sign 1101. When the vehicle passes the nearest guidance point indicated by the nearest guidance sign 1101, the contents of a guidance point indicated by the second guidance sign 1102 (arrow representing straight direction) is displayed on the nearest guidance sign 1101, and the second and third guidance signs 1102 and 1103 are displayed at the center in correspondence to the straight direction.

In FIG. 12, a nearest guidance sign 1201 displayed on a guidance image 1200 indicates a right-turn direction. The second guidance sign 1102 and the third guidance sign 1103 are arranged on the right according to the direction indicated by the nearest guidance sign 1201. These guidance images 1100 and 1200 are not just for guidance by guidance signs alone, but for guidance with directionality that is given to the guidance images 1100 and 1200 themselves. This enables display of a screen that allows the user to easily grasp the direction of the nearest guidance point instantaneously.

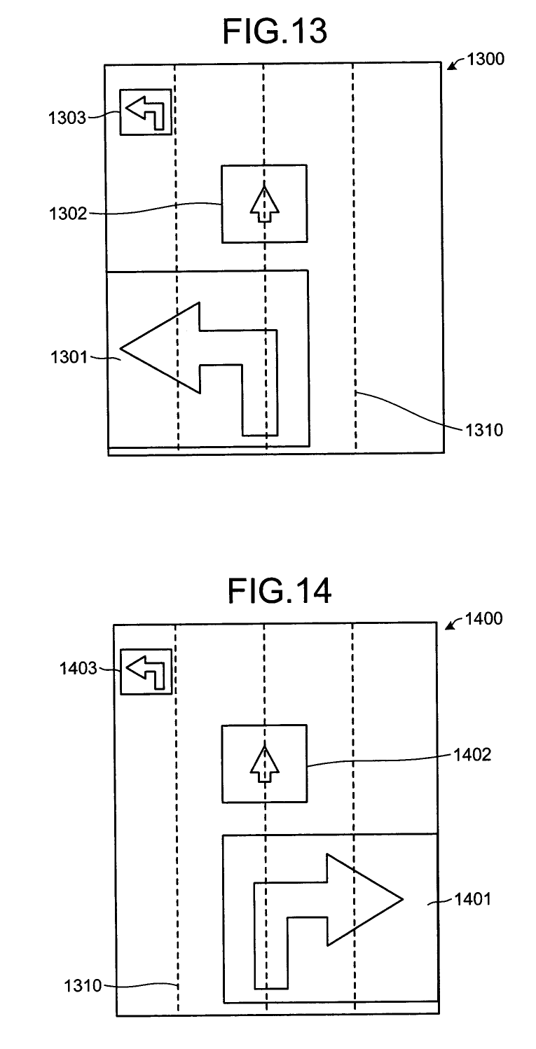

FIGS. 13 and 14 are explanatory diagrams of examples of guidance images in the case of arranging the guidance signs according to the direction indicated by the guidance signs, respectively. In FIG. 13, a guidance image 1300 displays a nearest guidance sign 1301, a second guidance sign 1302, a third guidance sign 1303, and area dividing lines 1310. The nearest guidance sign 1301 and the third guidance sign 1303 indicate a left-turn direction, and are each arranged on the left according to the left-turn direction. The second guidance sign 1302 indicates a straight direction, and is disposed at the center in correspondence to the straight direction. The area dividing lines 1310 are the lines for clarifying arrangement locations of the right, the left, and the center. The area dividing lines 1310 are displayed arbitrarily, and may be omitted from the display.

In FIG. 14, a nearest guidance sign 1401 displayed on a guidance image 1400 indicates a right-turn direction, and is disposed on the right according to the right-turn direction. The second guidance sign 1402 indicates a straight direction, and is disposed at the center according to the straight direction. A third guidance sign 1403 indicates a left-turn direction, and is disposed on the left according to the left-turn direction. These guidance images 1300 and 1400 make it easier for the user to know at a glance in which direction to proceed in order to reach the guidance point indicated by each guidance sign.

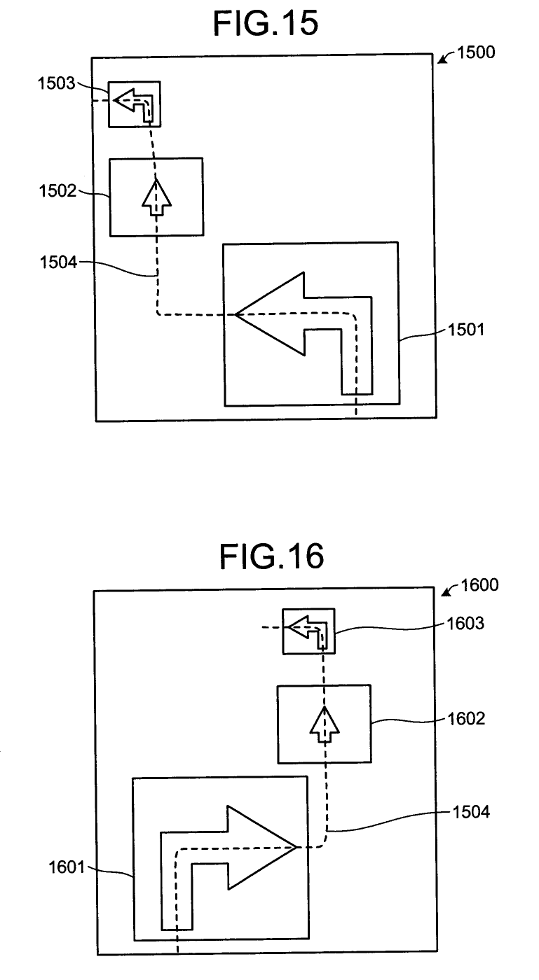

FIGS. 15 and 16 are explanatory diagrams of examples of guidance images where all displayed guidance signs are regarded as a single route. In FIG. 15, a guidance image 1500 displays a nearest guidance sign 1501 indicating a left-turn direction, a second guidance sign 1502 indicating a straight direction, a third guidance sign 1503 indicating a left-turn direction, and an auxiliary line 1504. The nearest guidance sign 1501 is disposed on the right, while the second guidance sign 1502 is disposed at a location determined by a route starting at the head of the arrow of the nearest guidance sign 1501.

The third guidance sign 1503 is disposed at a location determined by a route starting at the head of the arrow of the second guidance sign. The auxiliary line 1504 is regarded as the route that passes through the guidance signs 1501 to 1503. The auxiliary line 1504 is displayed arbitrarily, and may be omitted from the display.

In FIG. 16, on a guidance image 1600, a nearest guidance sign 1601 indicates a right-turn direction, a second guidance sign 1602 indicates a straight direction, and a third guidance sign 1603 indicates a left-turn direction. These guidance signs 1601 to 1603 are arranged in the same manner as the guidance signs 1501 to 1503 so that a subsequent sign is disposed at a location determined by a route starting at the head of each arrow. These guidance images 1500 and 1600 enable the user to get an image the route to take ahead.

(Example of Sign Arrangement on Guidance Image)

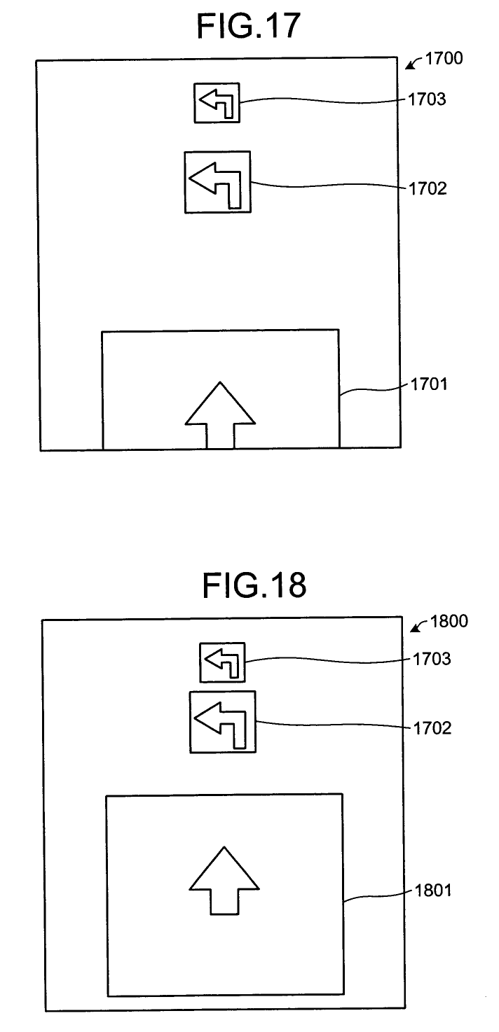

Examples of guidance images in the case of causing a nearest guidance sign to appear as an animated image will be described with reference to FIGS. 17 to 20. FIGS. 17 and 18 are explanatory diagrams of examples of guidance images where the nearest guidance sign indicating a straight direction appears as an animated image. In FIG. 17, a guidance image 1700 displays only the half of a nearest guidance sign 1701, a second guidance sign 1702, and a third guidance sign 1703.

The guidance image 1700 depicts a state where the nearest guidance sign 1701 is in the middle of its movement of emerging from a state of no appearance to ascend gradually. When the nearest guidance sign 1701 ascends further, the guidance image 1700 changes to a display screen 1800 of FIG. 18. The display screen 1800 of FIG. 18 exhibits a state where the nearest guidance sign 1801 has moved to its proper location.

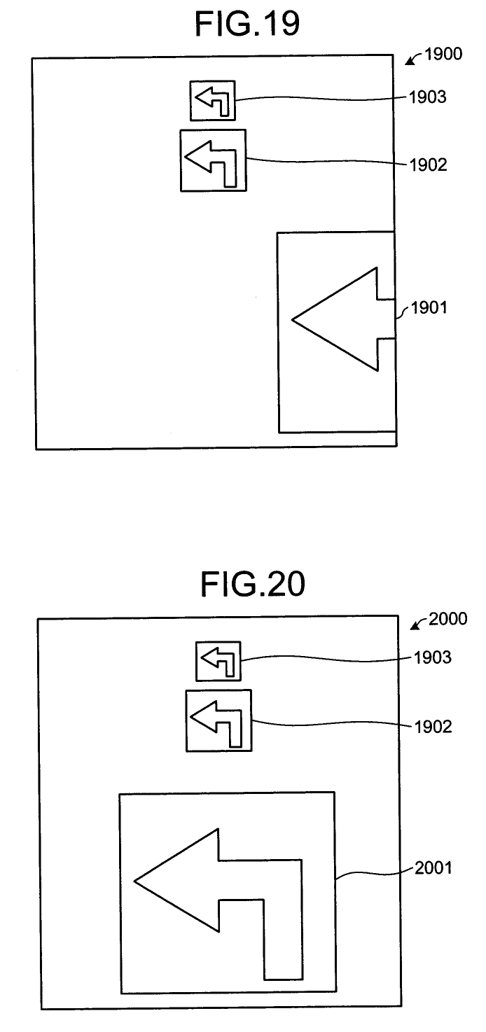

FIGS. 19 and 20 are explanatory diagrams of examples of guidance images where the nearest guidance sign indicating a left-turn direction appears as an animated image. In FIG. 19, a guidance image 1900 displays only the half of a nearest guidance sign 1901, a second guidance sign 1902, and a third guidance sign 1903. The guidance image 1900 depicts a state where the nearest guidance sign 1901 is in the middle of its movement of emerging from a state of no appearance to move leftward gradually. When the nearest guidance sign 1901 moves further leftward, the guidance image 1900 changes to a display screen 2000 depicted in FIG. 20.

The display screen 2000 of FIG. 20 depicts a state where a nearest guidance sign 2001 has moved to its proper place. These display screens 1700 to 2000 are displayed when the second guidance sign 1702 (1902) moves to the location of the nearest guidance sign 1701 (1901) after the vehicle has passed the nearest guidance point. Such appearance as an animated image is not limited to one time and may be performed several times in succession. For example, appearance as an animated image may be made once when the move to the location of the nearest guidance sign 1701 (1901) is made and then made several times in succession from the point in time when the distance to the nearest guidance point becomes equal to or less than 300 m until the point in time when the vehicle passes the nearest guidance point.

(Example of Display of Guidance Image for Displaying Guidance Sign Three-Dimensionally)

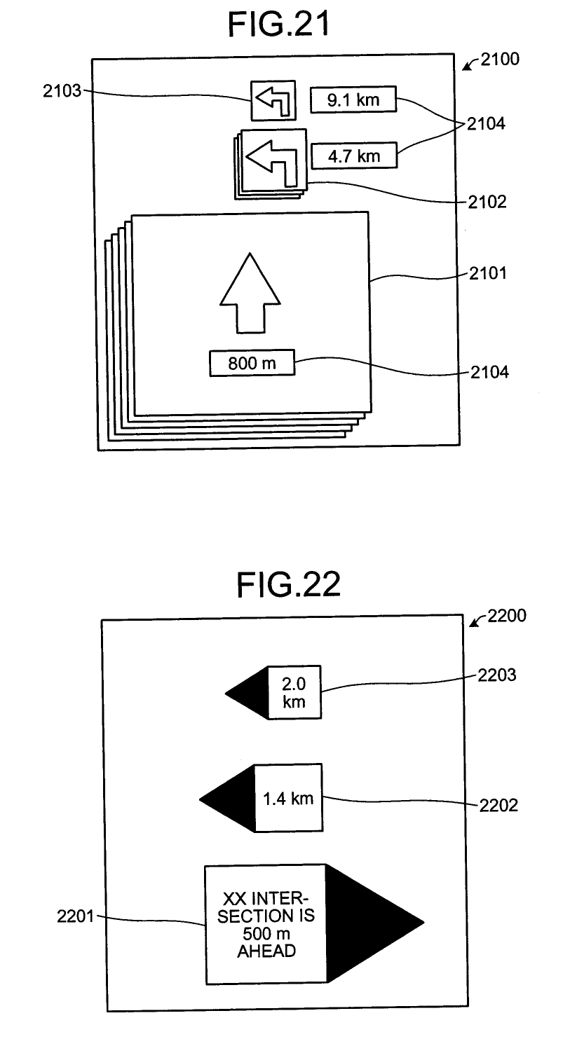

An example of display of a guidance image where a guidance sign is displayed three-dimensionally will be described with reference to FIG. 21. FIG. 21 is an explanatory diagram of an example of display of a guidance image where a guidance sign is displayed three-dimensionally. In FIG. 21, a guidance image 2100 displays a nearest guidance sign 2101, a second guidance sign 2102, and a third guidance sign 2103. Each of the guidance signs 2101 to 2103 accompanies display of a distance 2104 from the current point.

Each of the guidance signs 2101 to 2103 is displayed more three-dimensionally as the corresponding distance 2104 decreases. The guidance signs 2101 to 2103 are thus displayed three-dimensionally in a display form of a stacking of signs, and increase in thickness as the distance from the current point decreases. While the guidance signs 2101 to 2103 increase in planar area as well as in thickness in their display forms as the distance 2104 decreases, the guidance signs 2101 to 2103 may be kept constant in planar area and caused to change in thickness alone.

In such a display form, the nearest guidance sign 2101 may be caused to appear as an animated image and the second and third guidance signs 2102 and 2103 may be arranged on the side corresponding to the direction indicated by the nearest guidance sign 2101. The guidance image 2100 enables display of an image that gives a sense for the distance to each guidance point.

(Example of Guidance Sign Displayed in Other Shape)

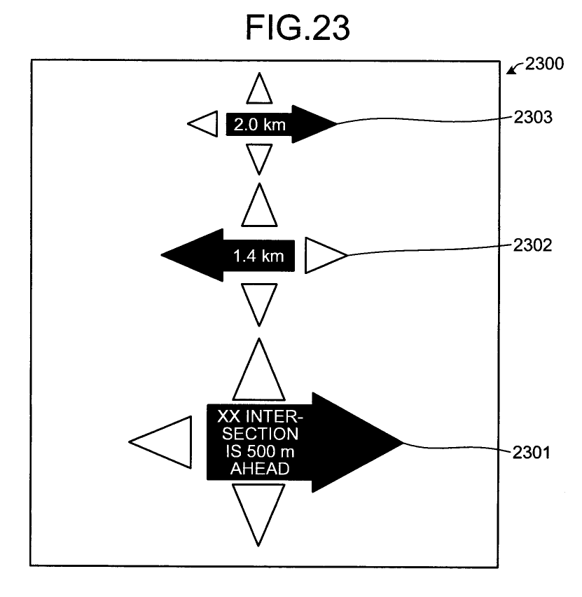

Examples of guidance signs displayed in other shapes will be described with reference to FIGS. 22 and 23. FIGS. 22 and 23 are explanatory diagrams of examples of guidance signs displayed in other shapes. A guidance image 2200 of FIG. 22 displays guidance signs 2201 to 2203 different in shape from the guidance signs described above. At each of these guidance signs 2201 to 2203, the distance from the current point is displayed, so that when the distance to the corresponding guidance point becomes equal to or less than 700 m, detail information, such as an intersection name, is displayed. When the distance to the guidance point becomes equal to or less than 300 m, a display color is changed.

A guidance image 2300 of FIG. 23 displays guidance signs 2301 to 2303 different in shape from the guidance signs described above. At each of these guidance signs 2301 to 2303, the distance from the current point is displayed, so that when the distance to the corresponding guidance point becomes equal to or less than 700 m, detail information, such as an intersection name, is displayed. When the distance to the guidance point becomes equal to or less than 300 m, the display color is changed. Using these images 2200 and 2300 offer the same effect as the guidance images described above, including the guidance image of FIG. 21, offer.

As describe above, according to the navigation apparatus, the navigation method, the navigation program, and the recording medium, the user is able to get a sense of distance, to know at a glance how much closer the user is to the next guidance point. Even if the user is unable to frequently check the display screen, therefore, the user is able to grasp information instantaneously in order to follow the guide route.

The navigation method described in the present embodiment may be implemented by executing a prepared program on a computer such as a personal computer and a workstation. The program is stored on a computer-readable recording medium such as a hard disk, a flexible disk, a CD-ROM, an MO, and a DVD, read out from the recording medium, and executed by the computer. The program may be a transmission medium that can be distributed through a network such as the Internet.

1-19. (canceled)

20. A navigation apparatus that provides guidance along a route to a destination using a guidance image on which a plurality of guidance signs, respectively indicative of a guidance direction at a guidance point, are arranged in order of proximity to a current point, the navigation apparatus comprising:
a setting unit that preliminarily sets a first given distance from the current point;
an extracting unit that extracts a given guidance point on the route;
a calculating unit that calculates a distance from the current point to the given guidance point extracted by the extracting unit; and
a display control unit that when the distance to the given guidance point calculated by the calculating unit becomes equal to or less than the first given distance, changes a color of a guidance sign at the guidance point to a color different from an current display color.

21. The navigation apparatus according to claim 20, wherein
the setting unit sets a second given distance that is a greater distance from the current point than the first given distance, and
the display control unit changes a display form of the guidance sign corresponding to the guidance point to a display form different from a current display form, when the distance to the guidance point calculated by the calculating unit is equal to or less than the second given distance.

22. The navigation apparatus according to claim 21, wherein
the display control unit controls a display form of the corresponding guidance sign at the time that the distance to the guidance point becomes equal to or less than the second given distance to be different from a display form of the corresponding guidance sign at the time when a distance to the guidance point becomes equal to or less than the first given distance.

23. The navigation apparatus according to claim 22, wherein
the display form of the corresponding guidance sign at the time when the distance to the guidance point becomes equal to or less than the second given distance is such that information indicative of details of the guidance point is added to the corresponding guidance sign to be displayed, and
the display form of the corresponding guidance sign at the time when the distance to the guidance point becomes equal to or less than the first given distance is such that information indicative of details of the guidance point is added to the corresponding guidance sign and a display color of the corresponding guidance sign is changed.

24. The navigation apparatus according to claim 20, wherein
the display control unit arranges all of the guidance signs displayed on the guidance image, on a side corresponding to a direction indicated by the guidance sign located nearest to the current point, a nearest guidance sign.

25. The navigation apparatus according to claim 20, wherein
the display control unit arranges the guidance signs displayed on the guidance image according to directions indicated by the guidance signs, respectively.

26. The navigation apparatus according to claim 20, wherein
the display control unit displays the guidance signs on the guidance image in such a way that a guidance sign is displayed in a size that increases as a distance from the current point to the corresponding guidance point decreases.

27. The navigation apparatus according to claim 20, wherein
the display control unit displays the guidance signs on the guidance image in such a way that a guidance sign is displayed to appear more three-dimensional as a distance from the current point to the corresponding guidance point decreases.

28. The navigation apparatus according to claim 27, wherein
the display control unit displays the guidance signs three-dimensionally as a stack of guidance signs, and increases thickness of a displayed guidance sign as a distance from the current point to the corresponding guidance point decreases.

29. The navigation apparatus according to claim 20, wherein
the display control unit displays the guidance signs on the guidance image together with additional information of respective distances from the current point to the guidance signs.

30. The navigation apparatus according to claim 20, wherein
the display control unit displays the guidance signs on the guidance image together with additional information of arrival times that correspond to the guidance signs.

31. The navigation apparatus according to claim 20, further comprising an acquiring unit that acquires point information concerning traffic signals set on the route to the destination, wherein
the display control unit, using the point information concerning traffic signals acquired by the acquiring unit, displays a quantity of the traffic signals to be passed during travel between guidance points, the quantity being displayed between guide signs corresponding to the guidance points.

32. The navigation apparatus according to claim 20, wherein
the display control unit causes the nearest guidance sign to appear as an animated image in a direction indicated by the nearest guidance sign.

33. The navigation apparatus according to claim 20, wherein
the nearest guidance sign is displayed as a touch panel, and
the display control unit displays on entire area of a display screen, a detailed map screen of a guidance point indicated by the nearest guidance sign, when the nearest guidance sign displayed as a touch panel is selected by a user.

34. The navigation apparatus according to claim 33, wherein
the detailed map screen displayed on the entire area of the display screen is displayed as a touch panel, and
the display control unit displays a screen on which the guidance image is used, when the detailed map screen displayed as a touch panel is selected by the user.

35. The navigation apparatus according to claim 20, further comprising:
a mode setting unit that sets a guidance image mode for guidance along a route, using the guidance image and a normal mode for guidance along a route, using a map screen alone without use of the guidance image; and
a receiving unit that receives selection of a mode set by the mode setting unit.

36. A navigation method of a navigation apparatus that provides guidance along a route to a destination using a guidance image on which a plurality of guidance signs, respectively indicative of a guidance direction at a guidance point, are arranged in order of proximity to a current point, the navigation method comprising:
extracting a given guidance point on the route;
calculating a distance from the current point to the given guidance point extracted at the extracting; and
controlling display, when the distance to the given guidance point calculated at the calculating becomes equal to or less than the first given distance, such that a color of a guidance sign at the guidance point changes to a color different from an current display color.

37. A non-transitory, computer-readable recording medium storing therein a navigation program causing a computer to execute:
extracting a given guidance point on a route along which a navigation apparatus provides guidance to a destination using a guidance image on which a plurality of guidance signs, respectively indicative of a guidance direction at a guidance point, are arranged in order of proximity to a current point;
calculating a distance from the current point to the given guidance point extracted at the extracting; and
controlling display, when the distance to the given guidance point calculated at the calculating becomes equal to or less than the first given distance, such that a color of a guidance sign at the guidance point changes to a color different from an current display color.
